(19) United States
(12) Patent Application Publication
(10) Pub. No.: US 2014/0138244 A1
(43) Pub. Date: May 22, 2014

(54) TEST STRIP FOR A MEDICAL METER

(71) Applicant: SANOFI-AVENTIS DEUTSCHLAND GmbH, Frankfurt am Main (DE)

(72) Inventors: Axel Teucher, Frankfurt am Main (DE); Michael Jugl, Frankfurt am Main (DE)

(21) Appl. No.: 14/131,077

(22) PCT Filed: Jul. 6, 2012
(86) PCT No.: PCT/EP2012/063293

§ 371 Date: Jan. 6, 2014

(30) Foreign Application Priority Data
Jul. 7, 2011 (EP) 11173095.8

(51) Int. Cl. G01N 27/327

(52) U.S. Cl. CPC G01N 27/3272
USPC 204/403.02

(57) ABSTRACT

A test strip for a medical meter) capable of analysing a sample of a bodily fluid comprises a first end and a second end opposite to the first end. The test strip is made from a rigid material and comprises a bended portion that is located between the first and the second end.

### CROSS REFERENCE TO RELATED APPLICATIONS

The present application is a U.S. National Phase Application pursuant to 35 U.S.C. §371 of International Application No. PCT/EP2012/063293 filed Jul. 6, 2012, which claims priority to European Patent Application No. 11173095.8 filed Jul. 7, 2011. The entire disclosure contents of these applications are herewith incorporated by reference into the present application.

### TECHNICAL FIELD

The present invention relates to a test strip for a medical meter capable of analysing a sample of a bodily fluid. More particularly, the invention relates to a test strip for use in combination with a blood glucose meter capable of determining a glucose level of a patient.

### BACKGROUND

Analysing the content of a bodily fluid for diagnosis is of particular interest in the medical field. Medical meters capable of analysing a sample of a body fluid are well-established in the state of the art. The medical meters are designed to determine a concentration of an analyte in the sample. In particular, a concentration of glucose, cholesterol or a hormone may be detected in a sample of interstitial fluid, blood or urine. Usually, the sample of the bodily fluid is applied onto a disposable test strip and introduced into the medical meter for analysis by capillary action.

Well-known examples for such medical meters are blood glucose meters capable of determining a glucose level of a patient by means of analysing a blood sample. Such devices are typically used by diabetics to properly dose insulin or an insulin derivate before an injection. The blood sample is applied onto a disposable test strip after indroduction into the re-usable blood glucose meter for analysis. Disposable test strips are used for reason of hygiene and to minimize the risk of infections with diseases transmitted by bodily fluids.

Various test strips adapted to be used with different medical meters are known. The medical meters of the state of the art utilize different measurement methods to determine the concentration of the analyte. Thus, test strips are required that are properly adapted to the specific medical meter for optimal accuracy of the measurement results.

Document EP 2 275 034 A1 describes a flexible test strip for use in combination with a blood glucose meter. The test strip has a blood sample volume detection area defined by electrical conductive contact elements that is located on a bending portion of the test strip. Blood may be applied on the blood sample volume detection area by bending the test strip, positioning the bending portion over a blood extraction site of a subject's body and passing a lancet through the bending portion and into the subject's body.

### SUMMARY

It is an object of the present invention to provide improved test strip for a medical meter that is safe and easy to handle.

The object is achieved by a test strip according to claim 1 and by a medical assembly according to claim 8.

Preferred embodiments of the invention are given in the dependent claims.

A test strip for a medical meter capable of analysing a sample of a bodily fluid comprises a first end and a second end opposite to the first end. The test strip is made from a rigid material. A bended portion of the test strip is located between the first and the second end.

The bended shape of the test strip improves manual handling of the test strip significantly. In particular, the test strip may be conveniently held between two fingers and may be easily inserted into the medical meter, so that a concentration of an analyte in the sample may be determined.

According to possible embodiments of the invention, the test strip is bended about an angle of between 20 degrees and 90 degrees to improve manual handling thereof

In one possible embodiment, the test strip is bended about an angle of approximately 90 degrees to provide an optimal viewing angle of the medical meter while the bodily fluid is extracted from an extraction site. For example, the test strip may be bended about an angle of 80-100 degrees, or about an angle of 85-95 degrees.

The first end may comprise an application area that is adapted to receive the sample of the bodily fluid. The bended shape of the test strip reduces the risk of accidentally touching the application area when the concentration of the analyte is measured. Thus, a contamination of the application area resulting in inaccurate measurement results may be prevented.

According to a possible embodiment of the invention, the application area is in fluid communication with a fluid transport channel or capillary. The sample of bodily fluid is initially applied to the application area and then transported into the fluid transport channel by capillary action.

The second end of the test strip may be adapted to be inserted into the medical meter. According to a possible embodiment of the invention, the test strip is designed to be used in combination with a blood glucose meter capable of determining the concentration of glucose in a blood sample. After the second end of the test strip is inserted into the blood glucose meter, a blood sample is applied to the application area section of the test strip for analysis. The asymmetric design of the test strip provided by the bended portion provides a visual aid that supports insertion the second end into the blood glucose meter in the proper orientation. Furthermore, the asymmetric design of the test strip may help to easily identify the end of the test strip that has to be inserted into the medical meter. This may also help to avoid accidental contaminations of the second end with the bodily fluid, in particular with blood.

According to an embodiment of the invention, the test strip comprises at least one electrical conductive contact element. Specifically, the test strip may be configured as a electrochemical blood glucose test strip with a plurality of contact elements arranged within the test strip as electrodes. The test strip may be prepared with a catalyst or an enzyme catalysing an oxidation of glucose. In particular, at least one of the electrodes may be coated with the catalyst. The concentration of glucose is determined by a conductivity measurement. The contact elements may be made from carbon, silver, silverchloride, gold, platinum or other suitable electrical conductive materials.

A medical assembly for analysing a sample of a bodily fluid comprises a test strip and a medical meter capable of analysing the sample. The test strip is configured to generate an electrical signal corresponding to a concentration of an analyte contained in the sample when connected to the medical meter for analysis. The bended portion of the test strip allows for a different handling when the concentration of the analyte is determined. More specifically, the medical meter and the test strip inserted thereinto may be conveniently held by a user in a manner that allows for a measurement of the concentration of the analyte in the sample while the application area of the test strip still rests on a blood extraction site.

The medical meter may comprise a display that is capable of displaying the measured concentration of the analyte. Due to the bended shape of the test strip, the medical meter with the test strip inserted thereinto may be orientated in a way that allows the user to conveniently read off the display while the application area still rests on the extraction site of the bodily fluid.

Specifically, the medical meter may be a blood glucose meter capable of determining a concentration of glucose in a blood sample.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a perspective view of a test strip;

FIG. 2 illustrates schematically the typical handling of the test strip;

FIG. 3 shows a perspective view of a medical meter with a test strip;

Corresponding parts are marked with the same reference symbols in all figures.

### DETAILED DESCRIPTION

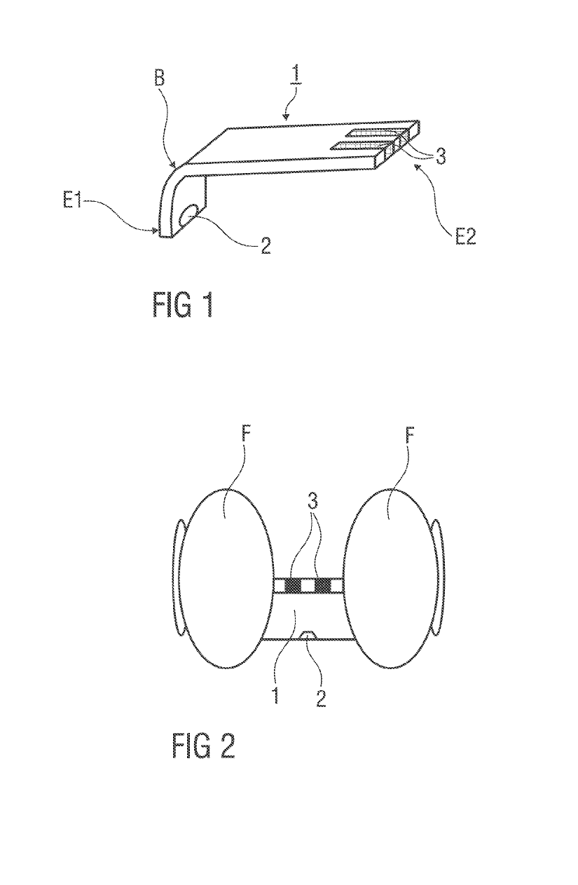

FIG. 1 shows perspective view of a test strip 1 according to an embodiment of the invention. The test strip 1 has a substantially L-shaped design with a first end E1 and a second end E2 opposite to the first end E1. The first end E1 has an application area 2 adapted to receive a sample of a bodily fluid, in particular blood. The application area 2 is in fluid communication with a fluid transport channel (not illustrated), so that the sample may be sucked into the test strip 1 by capillary motion.

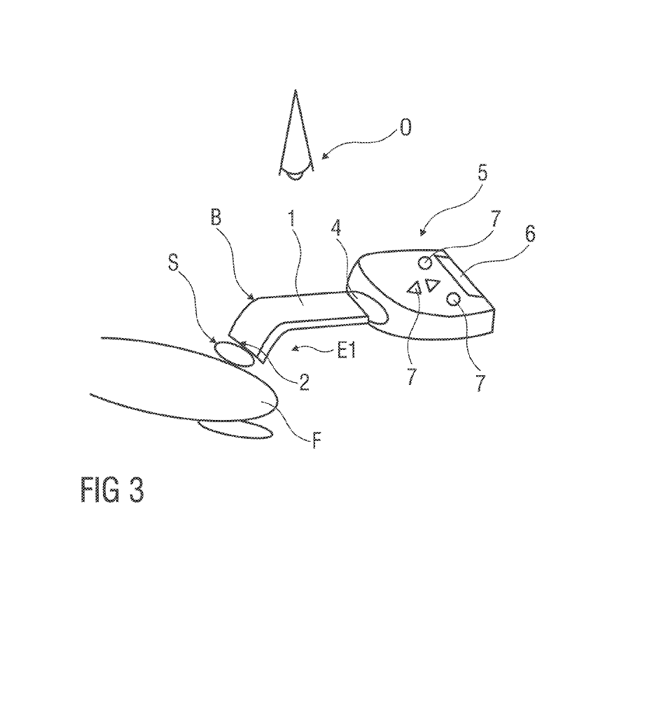

Contact elements 3 extend from the second end E2 into the test strip 1. The contact elements 3 are arranged as electrodes for determining a concentration of an analyte contained in the sample by a measurement of conductivity. The electrodes are in contact with the fluid transport channel or a sample chamber connected thereto so that an electrical current may be measured when the sample is introduced into the test strip 1. The second end E2 is configured to be inserted into an access port 4 of a medical meter 5 shown in more detail in FIG. 3. The contact elements 3 may be contacted with an electrical measurement circuit disposed within the medical meter 5 when the second end E2 is inserted into the access port 4 so that the concentration of an analyte contained in the sample may be determined.

In particular embodiments of the invention, the test strip 1 may be prepared with a catalyst or an enzyme catalysing the oxidation of glucose. The test strip 1 may be designed as a blood glucose test strip for a blood glucose meter. According to different embodiments of the invention, the concentration of glucose may be determined by various measurement techniques. In particular, chemical, electrochemical and/or enzymatic methods may be employed. Even more particularly, coulometric and/or amperometric methods may be used to determine the glucose level in the blood sample.

Additionally or alternatively, the application area 2 may be prepared with an indicator dye, so that the concentration of the analyte may be determined by change of colours when the bodily fluid is applied thereonto.

The test strip 1 has a bended portion B that is located between the first end E1 and the second end E2. In the exemplary embodiment shown in FIG. 1, the test strip 1 is bended about an angle of approximately 90 degrees. The test strip 1 is permanently bended into shape and is formed as a rigid, substantially bending-proof structure. By rigid, substantially bending-proof structure a mechanical component is characterized in such a way, that the application of bending stress on the component results either in a deformation that does not change the principal shape of the component, or, above some limit, in a persistent destruction of that mechanical component. In particular, a test stripe 1 formed as a substantially bending-proof structure provides sufficient lateral support so that operating the test stripe 1, i.e. touching it, inserting it into the medical meter, applying a sample of some bodily fluid on it shall not change its principal bended shape. In an example embodiment, the test strip is at least partially made from a rigid material. In a further example embodiment, the test strip 1 is made at least in part from at least one hydrophilic material.

The bended portion B of the test strip 1 is smoothly bended, so that the sample of bodily fluid may be transported along the fluid transport which is arranged within the test strip 1 and extends over the bended section B. According to various possible embodiments of the invention, the test strip 1 may be bended by an angle between 20 degrees and 90 degrees.

FIG. 2 illustrates schematically the typical handling of the test strip 1. The bended portion B of the test strip 1 provides an improved lateral support that facilitates gripping the test strip 1. The test strip 1 may be conveniently held between two fingers F and may be easily inserted into the access port 4 of the medical meter 5 before the sample fluid is applied onto the application area 2 for analysis.

FIG. 3 shows the test strip 1 inserted into the access port 4 of the medical meter 5 in a perspective view. The medical meter 5 comprises a display 6 capable of displaying the measured concentration of the analyte and a plurality of control elements 7 for adjusting the operation and display mode of the medical meter 5.

The application area 2 rests on an extraction site S of the sample fluid. In the exemplary embodiment shown in FIG. 3, a blood sample is extracted from the finger F of the user and applied onto the application area 2 for analysis. The bended portion B of the test strip 1 allows for a different handling of the medical assembly comprising the medical meter 5 and the test strip 1 when the concentration of the analyte in the sample is determined. The medical meter 5 with the bended test strip 1 may be arranged so that the user's view from an observation point O onto the medical assembly is not obstructed even while the first end E1 still rests on the extraction site S. This facilitates reading off a display 6 during the measurement.

Before a measurement of the concentration of the analyte is performed, the second end E2 of the test strip 1 is inserted into the medical meter 5. The sample of the bodily fluid is then applied onto the application area 2 of the test strip 1 and sucked into the fluid transport channel by capillary action. An electrical signal corresponding to the concentration of the analyte is generated and the measured results are displayed on the display 6 of the medical meter 5.

The bended portion B of the test strip 1 ensures that the application area 2 and the access port 4 of the medical meter 1 do not directly lie on a straight line. This reduces the risk that excess fluid applied to the application area 2 and flowing from the application area 2 along the test strip 1 may enter the medical meter 5 through the access port 4. A contamination of the medical meter 5 and thus a negative influence on the accuracy of the measurement results may be avoided.

The test strip 1 has a bended shape provided by the bended portion B located between the first and the second end E1, E2. The bended shape facilitates manual operation of the test strip 1 and helps to avoid contaminations of the medical meter 5.

1-11. (canceled)

12. A test strip for use in a medical meter capable of analysing a sample of a bodily fluid comprising a first end (E1) and a second end (E2) opposite to the first end (E1), wherein the test strip is made from a rigid material and comprises a bended portion (B) that is located between the first and the second end (E1, E2).

13. A test strip according to claim 12, characterized in that the test strip is bended about an angle of between 20 degrees and 90 degrees.

14. A test strip according to claim 12, characterized in that the test strip is bended about approximately 90 degrees.

15. A test strip according to claim 12, characterized in that the first end (E1) comprises an application area adapted to receive the sample of the bodily fluid.

16. A test strip according to claim 15, characterized in that the application area is in fluid communication with a fluid transport channel.

17. A test strip according to claim 12, characterized in that the second end is adapted to be inserted into the medical meter.

18. A test strip according to claim 12, characterized in that the test strip comprises at least one electrical conductive contact element.

19. A medical assembly for analysing a sample of a bodily fluid comprising a test strip according to claim 12 and a medical meter capable of analysing the sample.

20. A medical assembly according to claim 19, characterized in that the test strip is configured to generate an electrical signal corresponding to a concentration of an analyte contained in the sample when connected to the medical meter for analysis.

21. A medical assembly according to claim 19, characterized in that the medical meter is a blood glucose meter capable of determining a concentration of glucose in a blood sample.

22. A medical assembly according to claim 19, characterized in that the medical meter comprises a display adapted to display the measured concentration of the analyte.
